(19) United States
(12) Patent Application Publication
(10) Pub. No.: US 2009/0128313 A1
(43) Pub. Date: May 21, 2009

(54) Rotational speed display device

(76) Inventor: Stefan Lux, Meine (DE)

Correspondence Address: KENYON & KENYON LLP, ONE BROADWAY, NEW YORK, NY, 10004, US

(21) Appl. No.: 11/666,411

(22) PCT Filed: Jul. 17, 2005
(86) PCT No.: PCT/EP05/08447

§ 371 Date: Jul. 30, 2007

(30) Foreign Application Priority Data
Oct. 26, 2004 (DE) 10 2004 052 065.8

(51) Int. Cl. B60Q 1/00

(52) U.S. Cl. 340/441

(57) ABSTRACT

A rotational speed display device for a motor vehicle, having a dynamized display for a rotational speed warning, has an analog rotational speed display instrument and a screen, so that the screen and the rotational speed display instrument are visible to the driver in an overlapping manner, and the dynamized rotational speed warning is displayed on the screen within the area of the rotational speed display instrument.

The present invention relates to a rotational speed display device for motor vehicles, in which a dynamized display is provided as a speed warning, according to the definition of the species in Claim 1.

Rotational speed display instruments for motor vehicles have meanwhile become used in the majority of today's modern motor vehicles, usually a rotational speed range being displayed optically, in simple designs, which is not to be exceeded, to avoid damage to the internal combustion engine. Such warning displays normally include a first rotational speed range that is permissible for a short period, while a second range is not permissible, which can be prevented, for example, by shutting off the fuel supply. In classical round instruments having a graduated circle-like rotational speed scale, the ranges are shown optically for the driver, for instance, by an interrupted or solid circular red beam.

Now, in the case of these known rotational speed display instruments, such a static warning display is suitable only for engines that are at operating temperatures. For engines below operating temperature, that is, after the starting phase, or engines during their breaking-in phase, the permissible engine rotational speeds in the case of the static representation are usually too high and have to be avoided.

In order to do something about this disadvantage, one may see a rotational speed display instrument for motor vehicles in DE 101 08 934 A1, in which a variably illuminated scale part is provided, for the temperature-independent display of an upper rotational speed range of the internal combustion engine, that is to be avoided. Such a warning display is designated as a dynamized warning display. Using the scale range that can be variably illuminated, it is also possible to display the approach to the optimal shifting speed for a manual upshift.

The implementation of the warning display is a disadvantage in today's instruments clusters if additional circuit elements and/or illumination elements are used.

Therefore, the present invention is based on the object of creating a rotational speed display device having a dynamized rotational speed warning that makes possible a simpler generation of the dynamized rotational speed warning.

The object is attained by a rotational speed display device having the features of Claim 1. Preferred embodiments of the present invention are the subject matter of the dependent claims.

A rotational speed display device according to the present invention for a motor vehicle, having a dynamized display for a rotational speed warning has an analogous rotational speed display instrument and a screen, arranged in such a way that the screen and the rotational speed display instrument are visible to the driver in an overlapping manner, the dynamized rotational speed warning is displayed on the screen within the area of the instrument. In other words, the driver sees an analogous rotational speed display instrument and the screen in an overlapping fashion, as an optical unit.

Preferably, the analog rotational speed display instrument is an analog round instrument having an appropriate graduated circle-like rotational speed scale. Furthermore, the dynamized rotational speed warning is preferably shown as a round bar display on the screen, the bar display being situated especially in the area of the rotational speed scale, preferably below it. The dynamized warning can be made up of two areas, in a known manner, namely, one area that may briefly be reached as to rotational speed, and which, for example, is shown dashed, and a second area which is not admissible as to rotational speed, which is preferably visible to the driver as a solid, in particular, a red bar. The length and/or area covered or underlaid by the bar in the rotational speed scale is a function of the engine type and/or the engine temperature and/or the operating duration, preferably in kilometers, of the engine, that is, the internal combustion engine.

Furthermore, a display may be provided which shows the driver when an optimal shifting speed is close and/or has been reached, within the analog rotational speed display instrument on the screen.

The screen is preferably situated optically in the background of the analog rotational speed display instrument.

The device preferably has semitransmitting mirror, the screen, that is, the display being situated behind the semitransmitting mirror, in the direction of view of the driver, and the analog rotational speed display instrument being aligned with the semitransmitting mirror. Because of that, the driver has the impression that the analog rotational speed display instrument and the screen are arranged in an overlapping manner. In other words, the driver looks at the semitransmitting mirror, and sees the screen all the way through the mirror and the aligned analog rotational speed display instrument on the mirror, whereby a common image is generated for the driver. For reasons of restricted space in the motor vehicle, the analog rotational speed display instrument is preferably situated below the semitransmitting mirror, and is suitably illuminated in order to be visible to the driver as a mirror image in the semitransmitting mirror. The same applies to the illumination of the screen.

A preferred embodiment of the present invention is explained below on the basis of the only drawing.

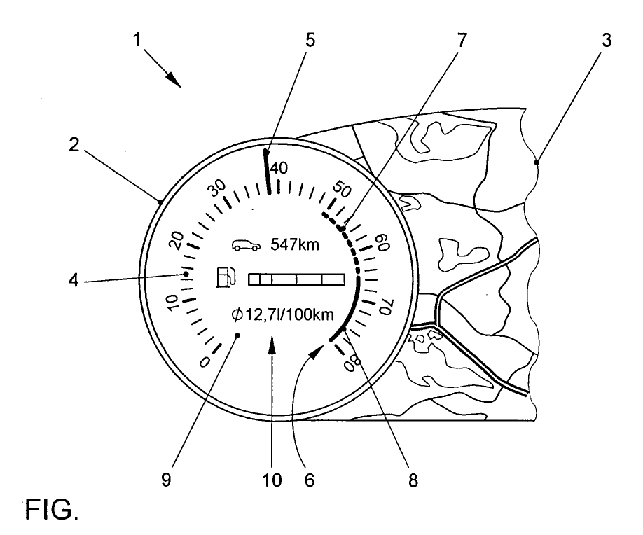

FIG. 1 shows a specific embodiment of the rotational speed display device.

The preferred specific embodiment of a rotational speed display device 1, shown in FIG. 1, includes an analog rotational speed display instrument 2, which is an analog round instrument in the present specific embodiment, as well as a screen 3, the optical impression being created that rotational speed display instrument 2 is situated in a floating manner in front of, or at least on the screen. As is shown schematically in FIG. 1, a road map of a navigation system, for example, can be shown on screen 3. Rotational speed display instrument 2 has a graduated circular rotational speed scale 4, having an indicator 5. Within rotary speed scale 4 there is a rotational speed warning display 6. Rotational speed warning display 6 is a function, for instance, of the engine temperature, and is therefore designed dynamically, and it has a first area 7, within which rotational speeds are briefly admissible, and a second area 9, within which rotational speeds are not permissible. When inadmissible region 9 is reached, the fuel supply can be interrupted, for instance, or other measures may be undertaken to reduce rotational speed. Rotational speed warning display 6 is situated on screen 3, and appears in inner area 9, that is, inner area 9 of rotational speed display instrument 2, so that a common optical impression is created for the driver. Inner area 9 of rotational speed display instrument 2 is therefore developed to be translucent or transparent. Other information 10, that is important to the driver, can also be shown in inner area 9 of rotational speed display instrument 2 on screen 3, so that here too, the optical impression is created for the driver that the other information 10 would appear within rotational speed display instrument 2. This optical effect can be attained using a semitransmitting mirror that, is not shown here, at which the driver looks, screen 3 being situated behind the semitransmitting mirror, while rotational speed display instrument 2 is arranged in such a way that, at suitable illumination, it appears as a reflected image on the semitransmitting mirror. Because of the superposition of the reflection of rotational speed display instrument 2 and screen 3, a common, overlapping optical impression is created for the driver.

### LIST OF REFERENCE SYMBOLS

1 Rotational speed display device
2 rotational speed display instrument
3 screen
4 rotational speed scale
5 indicator
6 rotational speed warning display
7 area briefly admissible
8 area inadmissible
9 inner area
10 other information

1-9. (canceled)

10. A rotational speed display device for a motor vehicle, comprising:
an analog rotational speed display instrument; and
a screen;
wherein the screen and the rotational speed display instrument are arranged to be visible to a driver in an overlapping manner, the screen configured to display a dynamized rotational speed warning within an area of the rotational speed display instrument.

11. The rotational speed display device according to claim 10, wherein the analog rotational speed display instrument is arranged as an analog round instrument including a graduated circular rotational speed scale.

12. The rotational speed display device according to claim 11, wherein the screen is configured to display the dynamized rotational speed warning as a graduated circular bar illustration.

13. The rotational speed display device according to claim 12, wherein the bar illustration in the area of the rotational speed scale is arranged under the rotational speed scale.

14. The rotational speed display device according to claim 13, wherein at least one of (a) a length and (b) a covered area of the rotational speed scale depends on at least one of (a) an engine type, (b) an engine temperature and (c) an operating time of an engine.

15. The rotational speed display device according to claim 10, wherein the screen is configured to indicate, within the analog rotational speed display instrument, at least one of (a) an approach to and (b) a reaching of an optimal shifting rotational speed.

16. The rotational speed display device according to claim 10, wherein the screen is configured to act optically in a background of the analog rotational speed display instrument.

17. The rotational speed display device according to claim 10, further comprising a semitransmitting mirror, the screen arranged behind the semitransmitting mirror, the analog rotational speed display instrument aligned with the mirror.

18. The rotational speed display device according to claim 17, wherein the analog rotational speed display instrument is arranged in the motor vehicle under the semitransmitting mirror.

19. A motor vehicle, comprising:
a rotational speed display device including:
an analog rotational speed display instrument; and
a screen;
wherein the screen and the rotational speed display instrument are arranged to be visible to a driver in an overlapping manner, the screen configured to display a dynamized rotational speed warning within an area of the rotational speed display instrument.
